(19) United States
(12) Patent Application Publication
(10) Pub. No.: US 2007/0118484 A1
(43) Pub. Date: May 24, 2007

(54) Conveying reliable identity in electronic collaboration

(75) Inventors: Nathaniel S. Borenstein, Ann Arbor, MI (US); Andrew S. Myers, Wayland, MA (US); Mary Ellen Zurko, Groton, MA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/284,995

(22) Filed: Nov. 22, 2005

(51) Int. Cl. G06Q 99/00

(52) U.S. Cl. 705/75

(57) ABSTRACT

A method, system, and program product stored on a computer-readable medium, for conveying reliable identity in electronic collaboration that includes evaluating information element(s) of an electronic interaction (e.g., message) so as to obtain a “confidence value” of the identity of the sender of the electronic interaction, based on the evaluation of the information element(s) and then mapping, on a spectrum, either in a visual, aural, haptic olfactory, or a combination of modes, the “confidence value” to the electronic interaction sender. May be employed in e-mail, VoIP, instant messaging, and the like.

### FIELD OF THE INVENTION

The invention relates generally to electronic collaboration (e.g., e-mail, instant messaging, Voice Over Internet Protocol, etc.), and more particularly, to a solution for conveying a reliable identity in electronic collaboration.

### BACKGROUND OF THE INVENTION

In the arena of electronic collaboration and communication, whenever the identity of a participant (e.g., sender of electronic interaction) is fraudulent problems may arise. For example, with electronic mail (i.e., e-mail) “spamming” (e.g., unsolicited e-mail) and “phishing” (i.e., fraudulent e-mail used to obtain valuable, confidential information such as Social Security Numbers, credit card numbers, passwords, and the like) are just two of the scourges that are facilitated by the use of forged or misleading sender identity information. The cost, both in time and real, due to forged or misleading identity information in e-mail, is incalculable. Current mail clients do not address the identity of the e-mail sender well.

Various fields may convey some aspect of the identity of the sender, including “Sender:”; “ReSent-From:”; “ReSent-Sender:”; “Reply-To:”; and, “Received:” (which shows the SMTP servers along the way, and, hence the sender to receiver ‘path’). Additionally, S/MIME (Secure Multipurpose Internet Mail Extensions), PGP (Pretty Good Privacy), or other digital signatures may contain the identity of the signer.

Some current e-mail clients will display an icon if a message is cryptographically signed with a recognized trust root (or make the information available in a dialog, like Lotus Notes). Others will tell the user if a signature exists, but cannot be verified with trust roots. The S/MIME specification requires that the name on the signature be checked against the name in the “From” field.

Although this information can lend credence to the actual, true identity of the sender, or raise a “red flag” to the e-mail recipient, most of the available information is so complex to the average e-mail user so as to render it opaque, in the sense that it is not discernible to the average e-mail user.

These shortcomings are not endemic to e-mail only. Other electronic collaboration forms, such as VoIP (Voice Over Internet Protocol, instant messaging, editing Wiki, netnews messages, and the like, suffer similar identity shortcomings.

To this extent, a need exists for a solution for conveying reliable identity in electronic collaboration that addresses the problems discussed herein and/or other problems recognizable by one in the art.

### BRIEF SUMMARY OF THE INVENTION

The invention provides a method for conveying reliable identity in electronic collaboration.

A first aspect of the invention provides a method of conveying reliable identity in electronic collaboration, the method comprising: evaluating at least one information element of an electronic interaction; obtaining a value from the evaluation step for the electronic interaction, wherein the value is representative of a confidence level of the identity of a second participant of the electronic interaction; and mapping the value along a spectrum to a first participant.

A second aspect of the invention provides a system for conveying reliable identity in electronic collaboration, the system comprising: a system for evaluating at least one information element of an electronic interaction; a system for obtaining a value from the evaluation step for the electronic interaction, wherein the value is representative of a confidence level of the identity of a second participant of the electronic interaction; and a system for mapping the value along a spectrum to a first participant.

A third aspect of the invention provides a program product stored on a computer-readable medium for conveying reliable identity in electronic collaboration, the program product comprising computer program code for performing the steps of: evaluating at least one information element of an electronic interaction; obtaining a value from the evaluation step for the electronic interaction, wherein the value is representative of a confidence level of the identity of a second participant of the electronic interaction; and mapping the value along a spectrum to a first participant.

A fourth aspect of the invention provides a method for deploying an application for conveying reliable identity in electronic collaboration, comprising: providing a computer infrastructure operable to: evaluate at least one information element of an electronic interaction; obtain a value from the evaluation step for the electronic interaction, wherein the value is representative of a confidence level of the identity of a second participant of the electronic interaction; and map the value along a spectrum to a first participant.

A fifth aspect of the invention provides a computer software embodied in a propagated signal for conveying reliable identity in electronic collaboration, the computer software comprising instructions to cause a computer system to perform the following functions: evaluating at least one information element of an electronic interaction; obtaining a value from the evaluation step for the electronic interaction, wherein the value is representative of a confidence level of the identity of a second participant of the electronic interaction; and mapping the value along a spectrum to a first participant.

The illustrative aspects of the present invention are designed to solve the problems herein described and other problems not discussed, which are discoverable by one in the art.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 shows an exemplary e-mail interface in list view format.

FIG. 2 shows an exemplary e-mail interface in message view format.

FIG. 3A shows an e-mail interface with embodiments for visually mapping the identity of an electronic collaboration in accordance with the present invention.

FIG. 3B shows an e-mail interface with other embodiments for visually mapping the identity of an electronic collaboration in accordance with the present invention.

FIG. 4 shows an e-mail interface aurally mapping the identity of an electronic collaboration in accordance with the present invention.

FIG. 5 shows a flow diagram for a method for conveying reliable identity in collaboration in accordance with the present invention.

FIG. 6 shows computerized system for conveying reliable identity in collaboration in accordance with the present invention.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a method for conveying reliable identity in electronic collaboration. As used herein, unless otherwise noted, the term “set” means one or more.

The present invention concerns the use of new techniques in user interface design to present complex and nuanced authentication information in a readily comprehensible manner. The present invention employs a valuation system or technique, the details of which may vary, to combine one, or more, elements of information from one, or multiple, sources about an electronic interaction's (e.g., message's) authentication into a single numerical value. This single numerical value, or identity “confidence value”, may be then mapped onto a spectrum of related possible presentations of the participant's identity that is related to the electronic interaction. The mapping may be presented in a visual, aural, haptic, olfactory mode, a combination of modes, or other presentation modes. The method and system employed, by the present invention, may be employed for any type of electronic interaction (e.g., e-mail message, instant message, VoIP call, netnews message, editing Wiki, etc.) with any type of electronic collaboration, including e-mail, instant messaging, VoIP, and the like.

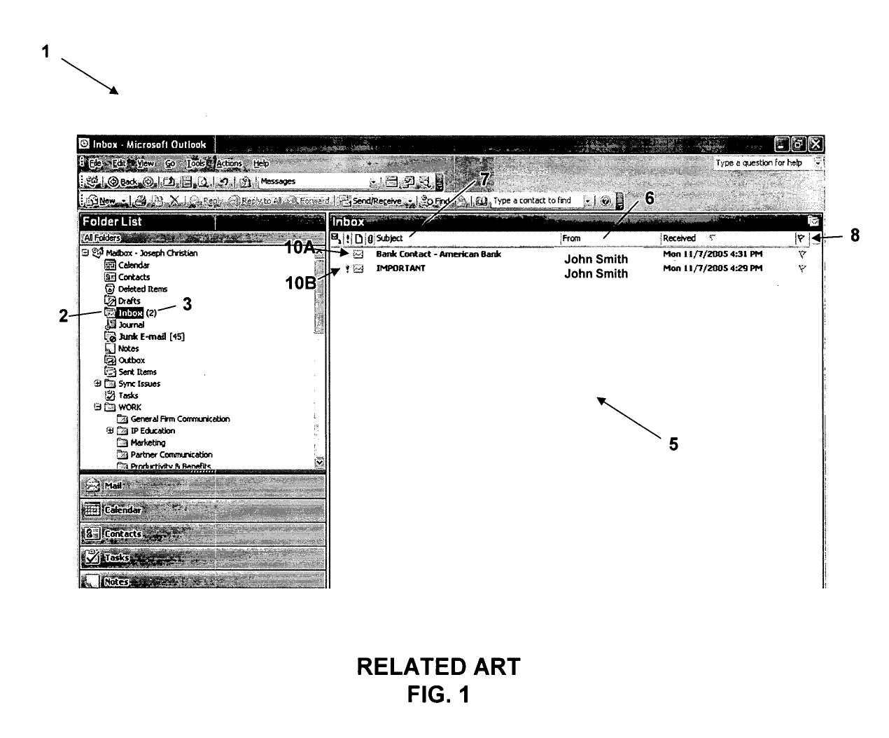

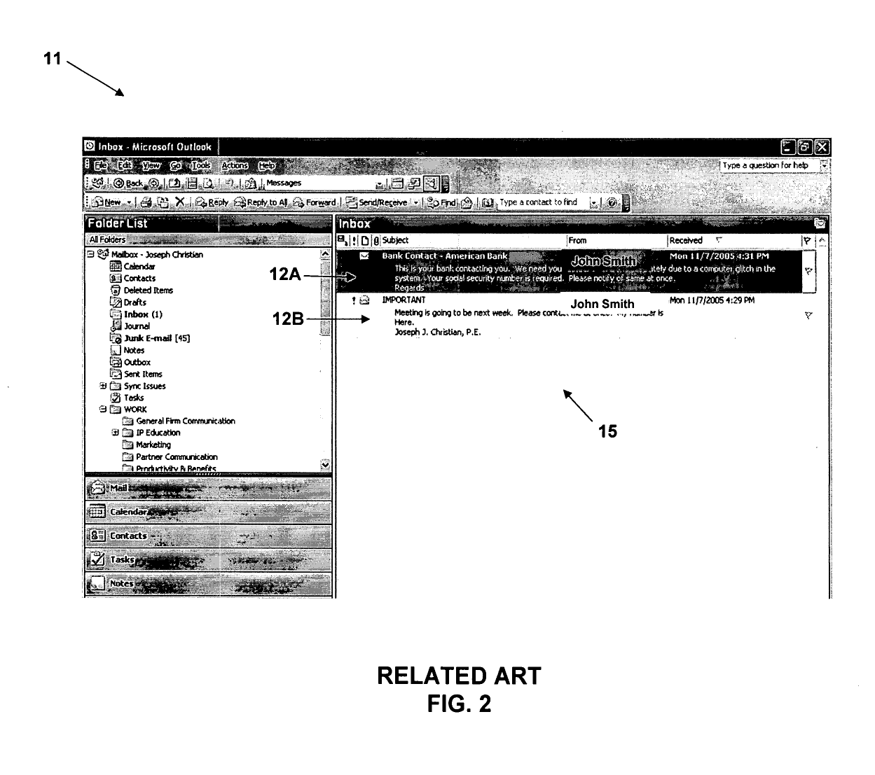

Turning to the figures, FIGS. 1 and 2, depict typical e-mail interfaces known in the art, wherein FIG. 1 shows what is commonly termed a “list view” 1 with a viewing frame 5, while FIG. 2 shows a “message view” 11 with a viewing frame 15. Message view 11 typically shows a portion of the e-mail messages 12 in the viewing frame 15, while list view 1 does not show a portion of the email message 10 in the viewing frame 5. Common to most e-mail interfaces is an “InBox” 2, which is an electronic version akin to a physical mail box, wherein newly received mail (i.e., e-mail messages) is sent to, or dropped off. As shown in the examples, messages arrive in the InBox 2 wherein, prior to opening the messages, a user can see a quantifier 3 (FIG. 1) which indicates the quantity of new, unopened e-mail messages that have arrived in the user's InBox 2. For example, in the list view 1 (FIG. 1), there exist two (2) new (i.e., unopened) messages in the InBox 2 as denoted by the “(2)” in the quantifier 3.

As shown, various fields 8 are available in a view 5, 15 to the user which may assist in providing information regarding a received e-mail message. By example only, a “Subject” field 7 (FIG. 1) may show a brief descriptor related to the e-mail. Similarly, the “From” field 6 may also show information related to whence the e-mail came. Unfortunately, both these fields 6, 7, and other fields 8, may be omitted and/or fraudulent.

As shown, in the example of the list view 1 (FIG. 1), the viewing box 5 includes two email messages 10A, 10B wherein “Subject” field 7 and “From” field 6 may be seen by the e-mail recipient. Similarly, in the example of the message view 11 (FIG. 2), the viewing box 15 includes two email messages 12A, 12B wherein further dialogue of the particular e-mail message is discemable to the e-mail recipient without opening the e-mail message.

In either example, opening and reading an e-mail message that is from a fraudulent, dubious, and/or undesirable e-mail sender is, at the least, a waste of time. In a worst case scenario, opening and complying with the contents of this type of e-mail message may be catastrophic.

The present invention will address the various shortcomings and ultimately increase the efficiency of an electronic interaction by reliably conveying the identity of an electronic interaction sender to the electronic interaction recipient, and hence the authenticity of the electronic interaction's content within the relevant electronic collaboration environment.

An evaluation system, or technique(s), is employed to obtain a confidence value. The evaluation system may vary according to local trust policies, philosophies, and the evolution of trust mechanisms. So too may the system vary over time. Input for the evaluation may be applied to one, or many information elements related to a particular electronic interaction (e.g., e-mail message), obtained from one, or a plurality of sources.

The contents of mail header fields such as “From”, “ReSent-From”, “Sender”, “Resent-Sender”, “Reply-To”, “Received” may be employed as an informational element(s) for the evaluation system. The evaluation system can employ as an informational element(s) other delivery traces, such as the IP address of the previous SMTP (Simple Mail Transfer Protocol) link, envelope information from incoming SMTP transactions, any available ISP (Internet Service Provider) authentication information, whether or not SSL (Secure Sockets Layer) was used, and other available logging information. The evaluation system can employ as an informational element(s) various cryptographic personal authentication information conveyed via S/MIME, PGP, or similar mechanisms, along with information about the trustworthiness of any relevant certifying authorities or reputation information available via third party reputation services. Another source for informational element(s) may include cryptographic domain authentication, such as the DKIM (Domain Keys Identified Mail) protocol now under consideration by the IETF (Internet Engineering Task Force). The evaluation system can employ as an informational element(s) various mail sending authorization policies published by the purported sender's domain. Examples include Meng Weng Wong's Sender Policy Framework (SPF) or Microsoft's SenderiD. The evaluation system can employ as an informational element(s) a receiver history, that indicates similar messages, with similar authentication traces, that may have been favorably, or unfavorably, received in the past. The evaluation system can employ as an informational element continuity history, such as e-mail traces that show consistency over time, and therefore are more likely to be genuine. While several of the sources for the informational elements are e-mail specific, there are analogues in other interpersonal electronic communication media such as instant messaging.

Ultimately, the present invention evaluates the single, or multiple, information elements from source(s) regarding the incoming electronic interaction (e.g., e-mail message), so as to obtain a particular value (i.e., “confidence value”) for the e-mail message. By example only, one possible methodology for evaluating would give each particular information element obtained a point rating. The information elements (i.e., points) are then added up. Certain subranges of the maximum value may be mapped to what is displayed ultimately to the user over a spectrum. The subranges may be visual, aural, haptic, olfactory, a combination, or other presentation modes. Other functions can privilege particular inputs with high marks against the maximum confidence value (i.e., weighting). For example, cryptographic personal authentication against a third party or organizational trust root might always score the maximum confidence value from the evaluation step.

By combining multiple informational elements, the confidence value obtained by the evaluation system typically increases. Each informational element has a particular relationship to the maximum, obtainable confidence value. The relationship may change over time as e-mail attackers find new penetration techniques. Similarly, new informational element(s) and/or source(s) may be added to the evaluation system over time, just as outdated or outmoded informational element(s) and/or source(s) may be removed from the evaluation system.

An example of an approach for the evaluation system would be to assign a number to each source, or class, of informational elements as follows: Mail header fields are denoted by a “1”; Other delivery traces are denoted by a “2”; Cryptographic personal authentication information is denoted by a “3”; Cryptographic domain authentication is denoted by a “4”; Mail sending authorization policies are denoted by a “5”; Collaborative context or receiver history is denoted by a “6”; Continuity history is denoted by a “7”; and, Policy assertion is denoted by an “8”.

Now applying the numbering system in a specific evaluation system, “3” (i.e., cryptographic personal authentication information) would represent the maximum confidence value automatically in the spectrum if there is a strong trust root. An “average” confidence value, along a spectrum, would be a combination of “1”, “2”, “6” and “7” (above), or whatever subset the particular e-mail system the e-mail recipient is tracking. However, items “6” and “7” (above) can not be applied to e-mail received from a new sender. Thus, for a new e-mail message, “1” and “2” (above) can be used in the evaluation system, with “4” or “5”, for example, giving an above average confidence level. By adding “8” to the evaluation system confidence value is increased. If “3” is obtained, but without the trust root, then “6” or “7”, or an out of band communication, should be obtained for the confidence value to be valuable.

Once the confidence value is obtained by the evaluation system, it is then mapped (i.e., made available) in some fashion to the user, or participant. The mapping is done along a spectrum, wherein the spectrum is either explicit or implicit to the user. Mapping of the identity confidence value to the participant may be visual, aural, haptic, olfactory, a combination of modes, or other presentation modes.

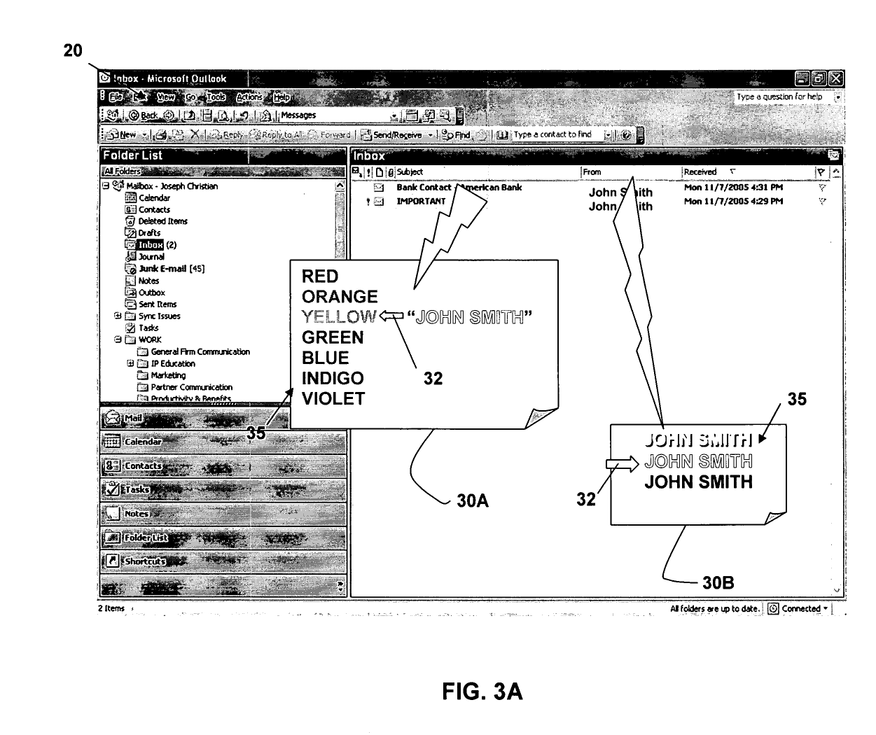

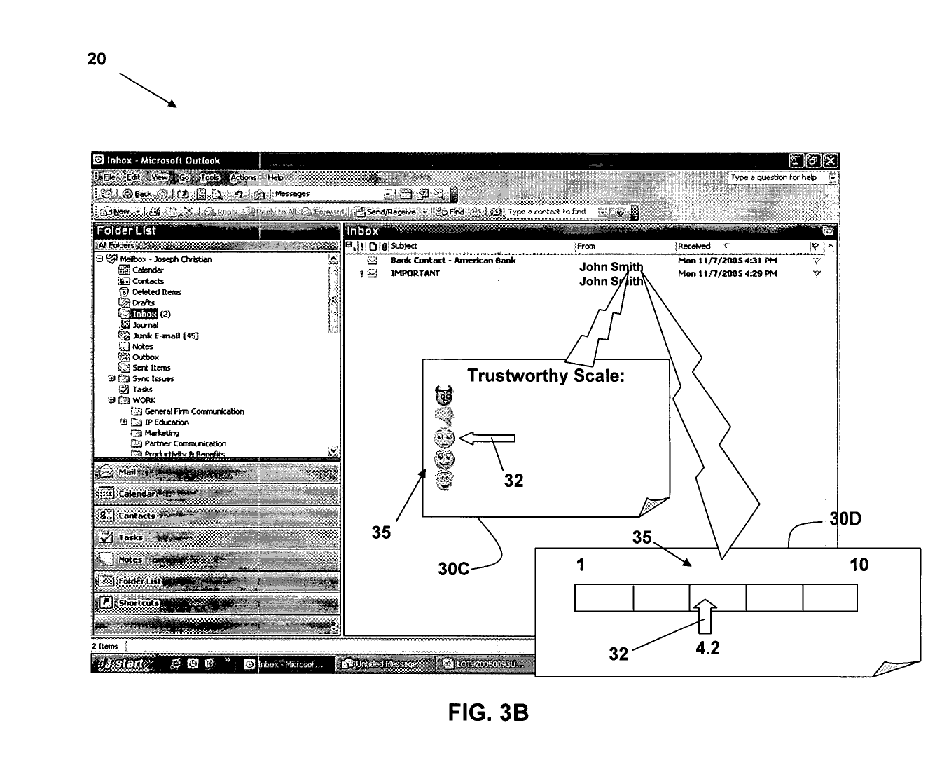

FIGS. 3A and 3B show various embodiments of visual mapping, shown in the examples in an environment where e-mail messages are sent. A list view screen 20 is depicted in FIG. 3A wherein two embodiments of visual maps 30 are provided on the screen 20. The first embodiment of visual map 30A includes a spectrum of colors. For example, “red” would connote likely forgeries, while “violet” connotes the strongest authentication available. Applying the evaluation system to a particular e-mail message obtains a value, for example, towards the middle of the spectrum. The e-mail sender's name (e.g., “John Smith”) may appear in a yellow font, wherein the color yellow is slightly towards the unreliable end of the spectrum.

The mapping may include using fonts wherein the variation of the font reflects the differing confidence value along a spectrum. For example, as the visual mapping 30B shows, the font could be a set of outline fonts wherein the interior of the sender's name would become more darkly filled in, as the identity confidence increases. The confidence value of the sender, John Smith, is denoted by the arrow 32, wherein it is approximately in the middle of the spectrum (i.e., average confidence level) and thus the font is partially filled in.

The mapping may include a range of icons that annotate the sender's name, thereby conveying a range of emotion or range of familiarity. For example, visual map 30C (FIG. 3B) shows spectrum 35 of icons, wherein the lowest confidence value is denoted by a devil's face, while the highest confidence value is denoted by an angel's face. The value obtained 32 is shown as a curious face thereby connoting an average confidence value. Similarly, visual map 30D shows a spectrum 35 that is merely numerical in value with a value obtained 32, in the example, of “4.2” along the spectrum 35 of “1” to “10”, wherein “10” connotes the highest confidence value obtainable.

Visual mapping may employ any single, or combination of the various, visual mapping techniques. The visual mapping may be employed with the list and/or message view. The spectrum 35 may be mapped along with the value 32, or may be physically omitted in the view, if the spectrum 35 may be implied by the particular value 32 depicted in the view.

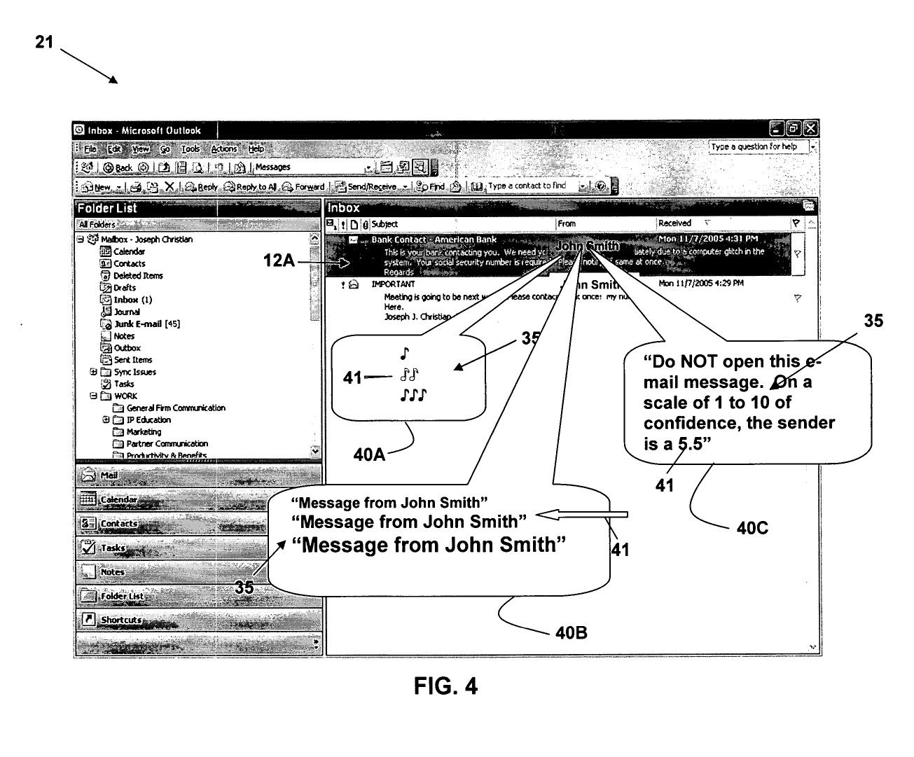

Auditory mapping can include a spectrum 35 and confidence value 41 provided to the e-mail user. Various embodiments of auditory mapping 40 are depicted in FIG. 4. For example, background music to be played along with the sender's name. The music would vary depending on the particular confidence value 41 obtained. The music could be simple tones, bell sounds, and the like. Alternatively, the music could be a song, or a portion of a song, arranged or selected by the user, wherein a “friendly” song, tone, etc. (e.g., “Here Comes the Sun” by the Beatles) connotes a high confidence value 41. Contrastingly, a serious or ominous song, tone, etc. (e.g., Beethoven's 5^{th} Symphony or theme from the movie “Jaws”) may connote a low confidence value 41.

The embodiments of auditory mapping 40A, 40B, 40C are depictions of a value 41 along an aural spectrum 35. For example, in the first auditory mapping 40A, the tone played 41 (i.e., value) may be either approximately halfway up a musical scale (i.e., spectrum 35) or a volume played 41 (i.e., value) that is approximately halfway up a spectrum 35 of available volumes. The second auditory mapping 40B depicts a value 41 along a spectrum 35 wherein a voice says “Message from John Smith” in a volume that is medium (i.e., approximately halfway along spectrum 35). Similarly, the third auditory mapping 40C, may be a voice message that reads a message with the value 41 obtained in it. The voice message may, or may not, include the spectrum 35 along with the value 41.

Similarly, a spectrum 35 of tones, or a set of voices of differing “friendliness”, may be employed. An explicit spoken indication of the identity confidence level 41 can be used as shown in the third auditory mapping 40C. Alternatively, the spectrum may be indicated by the volume of the auditory message connotes the confidence value 41.

Auditory mapping may employ any single, or combination of the various, auditory mapping techniques. For example, the auditory mapping may be the tone, volume, type of auditory message delivered, or a combination of these. The auditory mapping may be employed with the list and/or message view. The spectrum 35 may be mapped along with the value 41, or may be omitted, if the spectrum 35 may be implied by the particular value 41 provided in the auditory mapping.

Olfactory mapping may employ various techniques known in the olfactory emission sciences. Various scents that have generally positive or negative associations may be synthesized and emitted, as applicable. For example, if the value 41 obtained along the spectrum 35 is low, an odor that is generally considered negative (e.g., rotten egg smell) may be emitted. Conversely, if the value 41 is relatively high, an odor that is generally considered positive (e.g., lilac smell).

Haptic mapping may employ various techniques known in the haptic sciences. For example, force feedback against a human muscle(s) may be used. External physical pressure(s) of varying degrees, types, and/or location (e.g., touch or a pinprick) may be employed. Similarly, electrical, liquid, heat, or chemical changes that arc induced in the skin, lungs, or organs may be employed via haptic mapping. So too may direct feedback and interaction with human brainwaves be used as part of the haptic mapping. Thus, for example, if the value 41 along the spectrum 35 is relatively high (i.e., higher confidence level), then a pleasant massage may be mapped and transmitted to the participant, thereby connoting a positive experience. Similarly, if the value 41 along the spectrum 35 is relatively low (i.e., lower confidence level), then a mild electric shock may be mapped and transmitted to the participant, thereby connoted a negative experience.

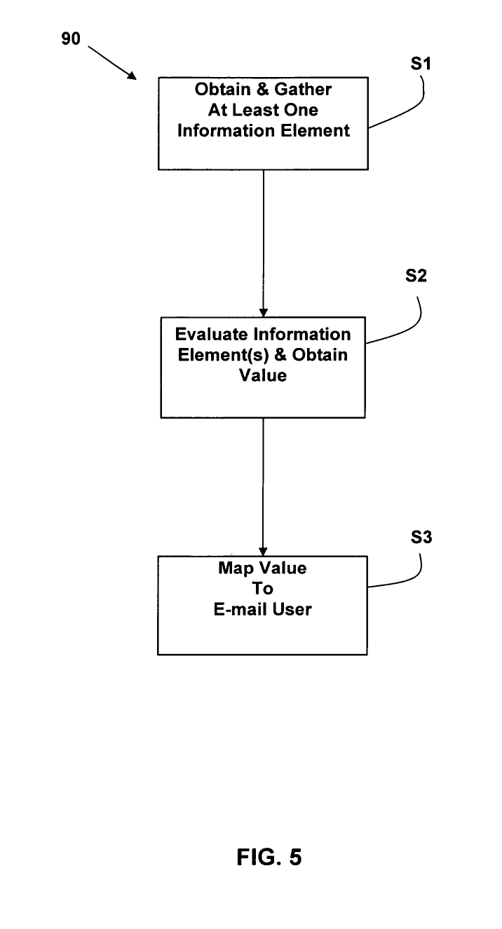

A method 90 for conveying reliable identity in electronic collaboration is depicted in FIG. 5. FIG. 5 shows an embodiment wherein the electronic collaboration and electronic interaction is via e-mail. Step S1 includes obtaining and/or gathering at least one information element of an electronic interaction (e.g., e-mail message). Step S2 follows and includes evaluating the information element(s) gathered/obtained and obtaining from the evaluation a value that is representative of the confidence level of the identity of the second participant (e.g., e-mail message sender). Step S3 includes then mapping to a first participant (e.g., e-mail user or recipient) the value along a spectrum of values.

The present invention ultimately provides the advantage of conveying reliable identity in electronic collaboration.

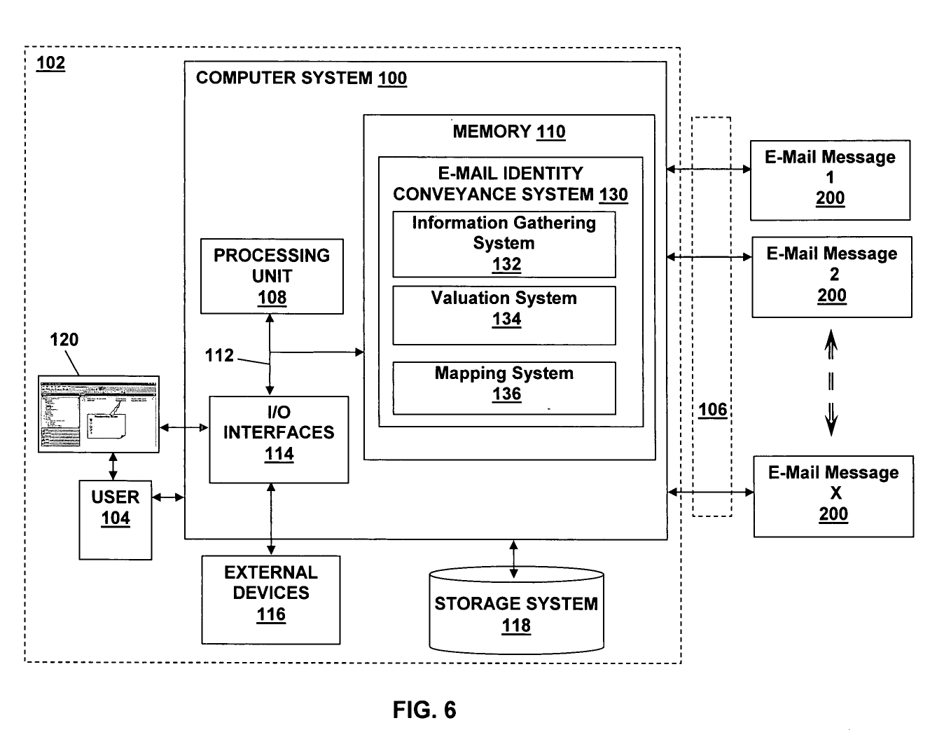

A computer system 100 for conveying reliable identity in electronic collaboration in accordance with an embodiment of the present invention in an e-mail environment is depicted in FIG. 6. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a service for conveying reliable identity in electronic collaboration, in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as E-mail Identity Conveyance System 130, and notification system 140, that are stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 6 can be included in computer system 100. However, if computer system 100 comprises a handheld device or the like, it is understood that one or more external devices/resources 116 (e.g., display 120) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 (e.g., e-mail recipient) can contain computerized components similar to those described above with regard to computer system 100.

Shown in memory 110 (e.g., as a computer program product) is an E-mail Identity Conveyance System 130 for conveying to a user 104 reliable identity of e-mail in accordance with embodiment(s) of the present invention. The E-mail Identity Conveyance System 130 generally includes an Information Gathering System 132 for obtaining one, or more, information elements of an email message 200, as described above. The E-mail Identity Conveyance System 130 generally also includes a Valuation System 134 for evaluating the information element(s), and obtaining a value for the e-mail message 200, wherein the value, or “confidence level” is representative of the reliability of the identity of the e-mail's sender, as described above. The E-mail Identity Conveyance System 130 generally includes a Mapping System 136 for mapping to the user 104 in a visual, aural, haptic, olfactory mode, a combination of modes, or other presentation modes the value of the e-mail message 200, as described above.

The present invention can be offered as a business method on a subscription or fee basis. For example, one or more components of the present invention can be created, maintained, supported, and/or deployed by a service provider that offers the functions described herein for customers. That is, a service provider can be used to provide a service for conveying reliable identity in e-mail, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk-read only disk (CD-ROM), a compact disk-read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of conveying reliable identity in electronic collaboration, the method comprising:
evaluating at least one information element of an electronic interaction;
obtaining a value from the evaluation step for the electronic interaction, wherein the value is representative of a confidence level of the identity of a second participant of the electronic interaction; and
mapping the value along a spectrum to a first participant.

2. The method of claim 1, wherein the electronic interaction is a e-mail message.

3. The method of claim 2, wherein the at least one information element is selected from the group consisting of: a mail header field, continuity history, receiver history, and combinations thereof.

4. The method of claim 3, wherein the mail header field is selected from the group consisting of: from, resent-from, sender, resent-sender, reply-to, received, and combinations thereof.

5. The method of claim 1, wherein the mapping step may be visual, aural, haptic, olfactory, or a combination thereof.

6. The method of claim 1, wherein the at least one information element is obtained from a plurality of sources.

7. The method of claim 1, wherein the obtaining step includes combining multiple sources of information.

8. The method of claim 1, wherein the spectrum is selectively displayed to the first paticipant.

9. The method of claim 5, wherein the visual mapping step comprises the use of one selected from the group consisting of: color, font, symbols, text, graphics, and combinations thereof.

10. The method of claim 5, wherein the aural mapping step comprises the use of one selected from the group consisting of: volume, tone, music, voice, music type, and combinations thereof.

11. The method of claim 5, wherein the olfactory mapping step comprises the synthesis of scents with positive or negative associations.

12. The method of claim 5, wherein the haptic mapping step comprises the use of one selected from the group consisting of: force feedback on human muscle; external physical pressure; changes induced in the body of the first participant; direct feedback and interaction with the first participant's brainwaves; and combinations thereof.

13. The method of claim 1, wherein the electronic interaction comprises one selected for the group consisting of: instant message (IM), voice over internet protocol (VoIP) call, Wiki, netnews message, and combinations thereof.

14. A system for conveying reliable identity in electronic collaboration, the system comprising:
a system for evaluating at least one information element of an electronic interaction;
a system for obtaining a value from the evaluation step for the electronic interaction, wherein the value is representative of a confidence level of the identity of a second participant of the electronic interaction; and
a system for mapping the value along a spectrum to a first participant.

15. The system of claim 14, wherein the electronic interaction is an e-mail message.

16. The system of claim 15, wherein the at least one information element is selected from the group consisting of: a mail header field, continuity history, receiver history, and combinations thereof.

17. The system of claim 16, wherein the mail header field is selected from the group consisting of: from, resent-from, sender, resent-sender, reply-to, received, and combinations thereof.

18. The system of claim 14, wherein the mapping system may be a visual system, an aural system, a haptic system, an olfactory system, or a combination thereof.

19. The system of claim 14, wherein the at least one information element is obtained from a plurality of sources.

20. The system of claim 14 wherein the obtaining system includes combining multiple sources of information.

21. The system of claim 14, wherein the spectrum is selectively displayed to the first participant.

22. The system of claim 18, wherein the visual mapping system includes the use of one selected from the group consisting of: color, font, symbols, text, graphics, and combinations thereof.

23. The system of claim 18, wherein the aural mapping system includes the use of one selected from the group consisting of: volume, tone, music, voice, music type, and combinations thereof.

24. The system of claim 18, wherein the olfactory mapping system comprises the synthesis of scents with positive or negative associations.

25. The system of claim 18, wherein the haptic mapping system comprises the use of one selected from the group consisting of: force feedback on human muscle; external physical pressure; changes induced in the body of the first participant; direct feedback and interaction with the first participant's brainwaves; and combinations thereof.

26. The system of claim 14, electronic interaction comprises one selected for the group consisting of: instant message (IM), voice over internet protocol (VoIP) call, Wiki, netnews message, and combinations thereof.

27. A program product stored on a computer-readable medium for conveying reliable identity in electronic collaboration, the program product comprising computer program code for performing the steps of:
evaluating at least one information element of an electronic interaction;
obtaining a value from the evaluation step for the electronic interaction, wherein the value is representative of a confidence level of the identity of a second participant of the electronic interaction; and
mapping the value along a spectrum to a first participant.
